(19) United States
(12) Patent Application Publication
(10) Pub. No.: US 2010/0035506 A1
(43) Pub. Date: Feb. 11, 2010

(54) Method for the Production and Insertion of an Electrode Frame Comprising a Lamp Coil into a Discharge Vessel of a Discharge Lamp

(76) Inventor: Klaus Pankratz, Freihalden (DE)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/311,761

(22) PCT Filed: Nov. 5, 2007
(86) PCT No.: PCT/EP2007/061884

§ 371 Date: Apr. 10, 2009

(30) Foreign Application Priority Data
Nov. 8, 2006 (DE) 10 2006 052 760.7

(51) Int. Cl. H01J 9/18

(52) U.S. Cl. 445/33

(57) ABSTRACT

The invention relates to a method for producing and inserting an electrode frame (1′) comprising a lamp coil (6) into a discharge vessel (7) of a discharge lamp. In said method, the following steps are carried out: a) two separate electrode holders (2′, 3′) are provided in the form of substantially elongate wires; b) an elongate brace (8) is fastened to the two spaced-apart electrode holders (2′, 3′); c) the lamp coil (6) is mounted on forward end regions (21, 31) of the electrode holders (2′, 3′); d) some sections of the electrode frame (1′) produced in steps a) to c) are inserted into the discharge vessel (7).

### TECHNICAL FIELD

The invention relates to a method for manufacturing and introducing an electrode frame with a lamp filament into a discharge vessel of a discharge lamp.

### PRIOR ART

DE 10 2004 004 655 A1 has disclosed a low-pressure discharge lamp which has an electrode, at least regions of which extend into a discharge vessel. The electrode comprises an electrode frame, which electrode frame comprises two live electrode holders consisting of Vakuvit wire. A lamp filament is fastened at the front ends of these two separate electrode holders. This subregion is located within the discharge lamp. A glass bead, which connects the two electrode holders and holds them, is likewise located within the discharge vessel. In the region in which the glass bead is attached, the electrode holders are bent in the form of a bottle neck.

FIG. 1 shows such a discharge lamp known from the prior art with a corresponding electrode frame, in a schematic illustration. The electrode frame 1 comprises the two electrode holders 2 and 3, which are connected to a glass bead 5 in a region 4 which is curved in tapered fashion and is arranged within a discharge vessel 7. A lamp filament 6 extends transversely

at the front ends of the electrode holders 2 and 3. The outwardly guided electrode holders 2 and 3 are pinched at a lower end region 71 of the discharge vessel 7 and fused into the material, with the result that the discharge vessel 7 is sealed in a gas-tight manner at this end region 71. A so-called wiping edge 72 is formed between the glass bead 5 and the end region 71, which wiping edge represents the lower limit of the phosphor coating of the discharge vessel 7.

The electrode frame 1 extends relatively far into the discharge vessel 7, as a result of which the discharge space is reduced. It results in a distance d1 between the lamp filament 6 and the lower end region 71 of approximately 20 mm. Furthermore, a distance d2 between the lamp filament 6 and the glass bead 5 is given a dimension of approximately 10 mm.

FIG. 2 shows an enlarged illustration of the electrode frame 1. It can be seen that the two electrode holders 2 and 3 are arranged very close to one another in the tapered region 4, in which the glass bead 5 is formed in the manner of a teardrop.

The known electrode frame 1 is produced using the so-called stem mount machine in a plurality of successive manufacturing steps. For this purpose, first the individual wires are directed towards the electrode holders 2 and 3, the wires are cut, the frame geometry is bent correspondingly and therefore the two electrode holders 2 and 3 are bent into their shapes shown, the glass bead 5 is positioned, the electrode frame 1 is bent into its final shape, the glass bead 5

is fused in, the electrode holders 2 and 3 are leveled off, hooks are bent at the front end regions of the electrode holders 2 and 3 in order then to be able to insert the lamp filament 6 there and to clamp it there. Then, a spreading dimension of the electrode holders 2 and 3 is bent, the lamp filament 6 is pasted, a final end dimension is bent and then the electrode frame 1 is inserted into a frame feed device.

The glass bead is used for stabilizing the electrode frame 1 during handling between individual processing steps up until the pinching of the end region 71. Disadvantages of this configuration with a glass bead can firstly be considered to be the fact that a special glass, for example OG131 with complicated production is required as the material for this purpose. Electrical insulation up to temperatures of approximately 600° C. needs to be ensured, which is not possible with conventional soft glasses. Furthermore, in the solution with a glass bead 5, no reliable EOL (end of life) response is ensured. During operation, situations can occur in which, despite the fact that the lamp filament 6 is broken, current is supplied to plastic parts, and these plastic parts then melt since the glass bead 5 is live. Furthermore, bead explosions can also occur in the operating positions. The production of such an electrode frame 1 known from the prior art and the introduction thereof into the discharge vessel of a discharge lamp is relatively complex and also very cost-intensive. Furthermore, undesirable faults can occur during operation which can result in damage or destruction of parts of the discharge lamp.

### DESCRIPTION OF THE INVENTION

The object of the present invention is therefore to simplify the production of such an electrode frame and the introduction thereof into a discharge vessel and to be able to provide an operationally more robust electrode frame.

This object is achieved by a method having the features according to patent claim 1.

In a method according to the invention for producing an electrode frame and for introducing such an electrode frame with a lamp filament into a discharge vessel of a discharge lamp, first two separate electrode holders in the form of substantially elongate wires are provided. Furthermore, an elongate strut is fastened on the two electrode holders, which are arranged spaced apart from one another. A lamp filament is attached at the front end regions of the electrode holders, with the result that this lamp filament extends between the two electrode holders. Regions of the electrode frame manufactured in this configuration are then introduced into the discharge vessel, with the result that at least the lamp filament is arranged within the discharge vessel. In particular owing to the attachment of an elongate transverse strut, the stability criterion of the electrode holders and therefore also of the entire electrode frame can be ensured. In this case, the stability is at least as great as during attachment of a droplet-like glass bead. Furthermore, it is possible to achieve an embodiment in which the electrode holders are spaced further apart

from one another in the region of this stabilizing element than in a configuration with a droplet-like glass bead. Furthermore, the elongate strut can be fastened on the electrode holders in a significantly more simple and cost-effective manner and is itself preferably made from materials which are substantially more favorable than an expensive glass bead, for example OG131.

Preferably, the electrode frame is introduced into the discharge vessel in such a way that the elongate strut is positioned outside of the discharge vessel. In addition to the ensured stability of the electrode frame, this arrangement can also ensure that the transverse strut is accessible at any point in time. After the gas-tight fuse-sealing and in particular after the pinching of the end region of the discharge vessel, into which the electrode frame extends, it is thus also possible for handling to take place using this elongate strut.

The elongate strut is preferably completely separated from the electrode holders once the regions of the electrode frame have been introduced into the discharge vessel. Preferably, this separation of the elongate strut takes place after pinching of an end region of the discharge vessel for sealing the discharge vessel in a gas-tight manner. The elongate strut is therefore used during production and introduction of the electrode frame into the discharge vessel for stabilizing purposes and can be removed, in particular after the pinch-sealing, once the electrode frame is in any case arranged in a mechanically stable fashion.

Preferably, the elongate strut is separated off prior to the pumping of the discharge vessel. Pumping is understood to mean the evacuation and filling of the discharge vessel with a filler.

The elongate strut is preferably fastened on the electrode holders so as to be at least 12 mm, in particular at least 15 mm, in particular at least 20 mm, spaced apart from the lamp filament. Owing to this spaced-apart arrangement, the entire electrode frame can be significantly shortened.

Preferably, the elongate strut is welded to the electrode holders. In this case, a welding operation corresponding to resistance welding has proven to be particularly preferred. The mechanically stable connection of the electrode frame can be ensured thereby during manufacture and primary introduction of the electrode frame into the discharge vessel.

The elongate strut preferably has a length of between approximately 5 mm and 10 mm. In particular, the length of this transverse strut is approximately 7 mm. This configuration makes it possible to achieve an embodiment in which the electrode holders are spaced apart from one another to a substantially greater extent in the region of the attached elongate strut than is the case in the prior art with the formation of a droplet-like glass bead. Short circuits between electrode holders arranged close to one another can thus be prevented.

Preferably, the elongate strut is in the form of an electrically conductive element. In particular, it can be provided for the elongate strut to be a wire, in particular

a Vakuvit wire. the elongate strut may also be formed from a corresponding material, particularly in embodiments in which the electrode holders also comprise such a wire, in particular in a Vakuvit wire. It is thus likewise possible to save on costs in terms of the procurement of material since a wire which is provided in any case can also be used for the elongate strut.

Preferably, the elongate strut has a diameter of approximately 0.4 mm. This also corresponds to the preferred diameter of the electrode holders. Such a thickness of the elongate strut makes it possible for it to be fastened to the electrode holders in a reliable manner and furthermore also ensures sufficient stability and position-holding of the electrode holders during the introduction and further fastening of the electrode frame on the discharge vessel.

In particular when the elongate strut is intended to be separated off from the electrode holders after the pinching of the end region of the discharge vessel, such an electrically conductive element can be used. Since this elongate strut is then in any case removed prior to actual operation of the discharge lamp, a possible current bridge, as would then arise as a result of the elongate strut, can also be prevented.

However, it can also be provided for the elongate strut to be formed from an electrically nonconductive material. For example, in this case a stable plastic or the like can also be provided. This can also be fastened on the

electrode holders in a wide variety of ways, with possible examples being adhesive bonding, bracing or the like. In this case, it can also be provided for an electrically nonconductive element to be formed with a corresponding temperature stability, with the result that it can also be provided for this elongate strut to be arranged within the discharge vessel if the electrode frame has been introduced into the discharge vessel and the end region at which the electrode frame is inserted has been pinched. Given such a material configuration of the elongate strut, said strut can also remain fastened permanently during operation of the discharge lamp since a current bridge is not produced in this regard.

Preferably, the elongate strut is formed with such a length that, once the strut has been attached to the electrode holders, the distance between the two electrode holders in the region of the attached strut substantially corresponds to the distance between the two electrode holders at the front end regions at which the lamp filament is attached. Multiple bending and forming of a tapered, bottle-like region of the electrode holders, as is required when forming a glass bead in the prior art, can thereby be prevented.

The configuration and manufacture according to the invention also make it possible to achieve an embodiment in which the electrode frame does not need to protrude as far into this discharge vessel as is the case in the prior art shown in FIG. 1. This can also result in an extension of the discharge space in the discharge vessel since, in the case of such

electrode frames without beads, the lamp filament can be lowered down as far as a so-called wiping edge. Since in the invention a relatively short electrode frame can thus also be achieved, the wire saved thereby can be used for an electrode holder in particular for the elongate strut. In comparison with the prior art, at most as much wire is therefore used, as a result of which a cost saving potential is in this case already provided.

Furthermore, the utilization ratio can be increased since no bead exclusions can occur. Furthermore, an increase in the performance of the stem mount machine can be achieved since geometrical bending and bead fusing, as is required in the prior art, is not needed. Since, furthermore, there is no current transfer, as can occur for example in the case of the glass bead in the prior art, the discharge lamp is also EOL-safe. Maintenance costs for bending tools and a fusing-in burner for introducing the glass bead can also be saved.

### BRIEF DESCRIPTION OF THE DRAWING(S)

An exemplary embodiment of the invention will be explained in more detail below with reference to schematic drawings, in which:

FIG. 1 shows a discharge vessel of a discharge lamp with an electrode frame known from the prior art;

FIG. 2 shows an enlarged illustration of the known electrode frame shown in FIG. 1;

FIG. 3 shows an instantaneous manufacturing phase of an electrode frame according to the invention during introduction into a discharge vessel of a discharge lamp; and

FIG. 4 shows an enlarged illustration of an electrode frame according to the invention in a further manufacturing step.

### PREFERRED EMBODIMENT OF THE INVENTION

Identical or functionally identical elements have been provided with the same reference symbols in the figures.

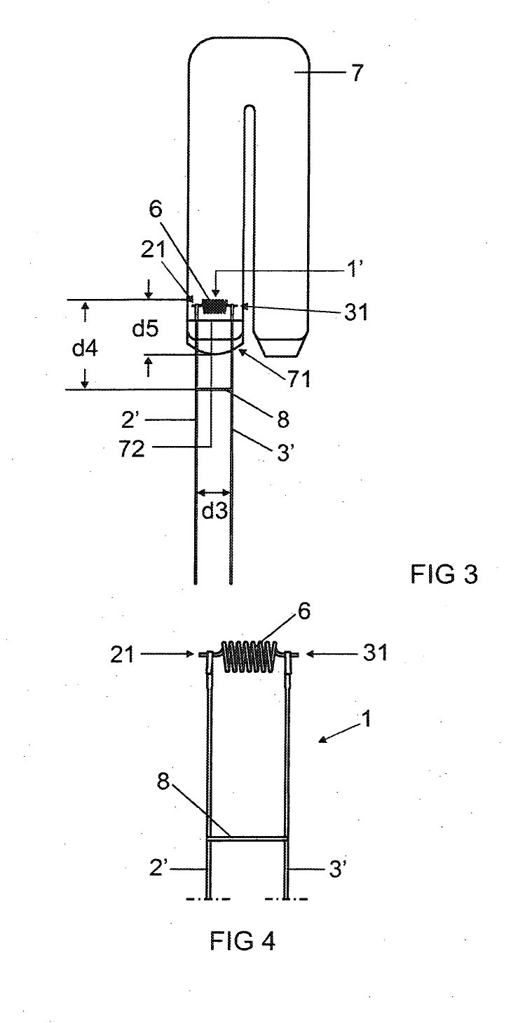

FIG. 3 shows a schematic illustration of a manufacturing stage of an electrode frame 1′, which is introduced into a discharge vessel 7 of a discharge lamp. The electrode frame 1′ is manufactured in its fundamental production from two electrode holders 2′ and 3′, a lamp filament 6′ and an elongate strut 8. First of all two separate wire pieces are provided for this purpose. In the exemplary embodiment, the electrode holders 2′ and 3′ comprise a Vakuvit wire and have substantially the same length. In a further manufacturing step, an elongate strut 8 is then fastened between the substantially parallel electrode holders 2′ and 3′. The elongate strut 8 is likewise formed from Vakuvit wire in the exemplary embodiment and has a diameter of approximately 0.4 mm, which also corresponds to the diameter of the two electrode holders 2′ and 3′. The elongate strut 8 is introduced as a transverse strut between the two electrode holders 2′ and 3′ and is fastened on the two electrode holders 2′ and 3′

by resistance welding. As can be seen both from the illustration in FIG. 3 and from the enlarged partial view in FIG. 4, the elongate strut 8 is set back with respect to the front end regions 21 and 31 of the electrode holders 2′ and 3′. In the exemplary embodiment, the distance d4 between these front end regions 21 and 31 of the electrode holders 2′ and 3′ in relation to the elongate strut 8 is approximately 15 mm.

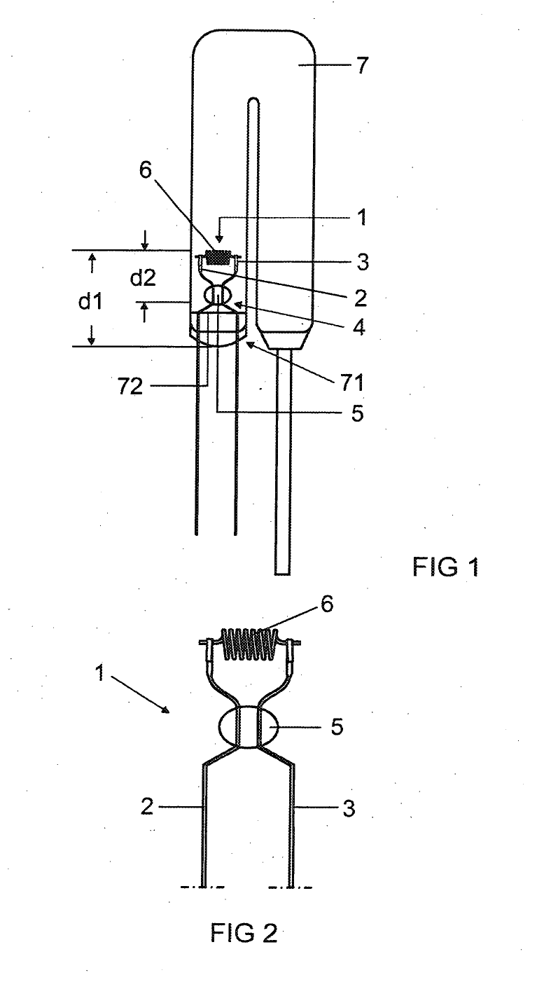

As can be seen both from the illustration in FIG. 3 and from the illustration in FIG. 4, the two electrode holders 2′ and 3′ extend parallel substantially over their entire length. The two electrode holders 2′ and 3′ do not have a tapered region, as is required in the prior art shown in FIG. 1 and FIG. 2 in the region 4. The electrode holders 2′ and 3′ therefore have a substantially constant distance d3 over their entire length. This distance is approximately 7 mm in the exemplary embodiment and therefore substantially corresponds to the length of the elongate strut 8.

Once the elongate strut 8 has been welded to the two electrode holders 2′ and 3′, the wires are leveled off. Then, hooks are bent at the front ends 21 and 31 and then the lamp filament 6 is inserted into these bent hooks and clamped there. Then, a spreading dimension of the electrode holders 2′ and 3′ is bent and the lamp filament 6 is pasted. There then follows bending of the end dimension of the electrode frame 1′ and insertion thereof into the frame feed device. In this manufacturing state, the electrode frame 1′ is finished in terms of its fundamental readiness. Then, this electrode frame 1′ is introduced into the discharge vessel 7. For this purpose, the front region on which the lamp filament 6 is fastened is inserted into the discharge space at one end region 71 of the discharge vessel 7. This follows in the exemplary embodiment to the extent that the elongate strut 8 is still located outside of the discharge vessel 7.

The electrode frame 1′ is inserted into the discharge vessel 7 to such an extent that a distance d5 is formed between the lamp filament 6 and the lower peripheral region of the end region 71. This distance is approximately 10 mm in the exemplary embodiment and is therefore substantially smaller, in particular smaller by one half, than the distance d1 in the conventional embodiment shown in FIG. 1. The electrode frame 1′ therefore needs to be inserted into the discharge vessel 7 to a significantly lesser extent, as a result of which the discharge space can be larger in comparison with the prior art.

The distance d4 between the lamp filament 6 and the elongate strut 8 is approximately 15 mm in the exemplary embodiment, as has already been explained. It can be seen that the electrode frame 1′ and therefore also the lamp filament 6 at the front ends 21 and 31 of the electrode holders 2′ and 3′ extend into the discharge vessel 7 beyond the wiping edge 72 by a relatively small value.

Starting from this manufacturing state shown in FIG. 3, the end region 71 is then heated and pinched, with the result that the electrode holders 2′ and 3′ are pinched into this end region 71 in a positionally

stable manner, and this end region 71 is sealed in a gas-tight manner.

Then, the elongate strut 8 is separated off from the electrode holders 2′ and 3′ by virtue of it being cut off, for example, with a corresponding cutting tool. Once this elongate strut 8 has been separated off, the pumping operation then takes place in the discharge vessel 7, in which process said discharge vessel is evacuated and corresponding filler material is introduced.

The enlarged illustration of the electrode frame 1′ shown in FIG. 4 shows a manufacturing state after the actual assembly of the parts of the electrode frame 1′ and prior to the introduction into the discharge vessel 7.

1. A method for manufacturing and introducing an electrode frame (1′) with a lamp filament (6) into a discharge vessel (7) of a discharge lamp, in which method the following steps are performed:
a) providing two separate electrode holders (2′, 3′) in the form of substantially elongate wires;
b) fastening an elongate strut (8) onto the two electrode holders (2′, 3′), which are arranged spaced apart from one another;
c) attaching the lamp filament (6) to front end regions (21, 31) of the electrode holders (2′, 3′);
d) introducing regions of the electrode frame (1′) manufactured in steps a) to c) into the discharge vessel (7).

2. The method as claimed in claim 1,
characterized in that
the electrode frame (1′) is introduced into the discharge vessel (7) in such a way that the elongate strut (8) is positioned outside of the discharge vessel (7).

3. The method as claimed in claim 1 or 2,
characterized in that
the elongate strut (8) is separated from the electrode holders (2′, 3′) once the regions of the electrode frame (1′) have been introduced into the discharge vessel (7).

4. The method as claimed in claim 3,
characterized in that
the strut (8) is separated off once an end region (71) of the discharge vessel (7) has been pinch-sealed.

5. The method as claimed in claim 3,
characterized in that
the strut (8) is separated off prior to the pumping of the discharge vessel (7).

6. The method as claimed claim 1,
characterized in that
the elongate strut (8) is fastened on the electrode holders (2′, 3′) so as to be at least 12 mm spaced apart from the lamp filament (6).

7. The method as claimed in claim 1,
characterized in that
the elongate strut (8) is welded to the electrode holders (2′, 3′.

8. The method as claimed in claim 1,
characterized in that
the elongate strut (8) is formed so as to be electrically conductive.

9. The method as claimed in claim 8,
characterized in that the elongate strut (8) is a wire, in particular a Vakuvit wire.

10. The method as claimed in claim 1,
characterized in that
the elongate strut (8) has such a length that, once the strut (8) has been attached to the electrode holders (2′, 3′), the distance (d3) between the two electrode holders (2′, 3′) in the region of the strut (8) substantially corresponds to the distance (d3) between the two electrode holders (2′, 3′) at the front end regions (21, 31).

11. The method as claimed in claim 6 wherein the elongated strut is fastened on the electrode holders so as to be at least 15 mm spaced apart from the lamp filament.

12. The method as claimed in claim 6 wherein the elongated strut is fastened on the electrode holders so as to be at least 20 mm spaced apart from the lamp filament.

13. The method of claim 7 wherein the welding is by resistance welding.
